(19) United States
(12) Patent Application Publication
(10) Pub. No.: US 2003/0188193 A1
(43) Pub. Date: Oct. 2, 2003

(54) Single sign on for kerberos authentication

(75) Inventor: Vishwanath Venkataramappa, Austin, TX (US)

Correspondence Address: Robert H. Frantz, P.O. Box 23324, Oklahoma City, OK, 73123, US

(73) Assignee: International Business Machines Corporation, Armonk, NY (US)

(21) Appl. No.: 10/112,499

(22) Filed: Mar. 28, 2002

(51) Int. Cl. H04L 9/00

(52) U.S. Cl. 713/201

(57) ABSTRACT

A single-sign-on process and mechanism for a client who wishes to access multiple servers in an environment, where the servers employ the Kerberos authentification process. During an initial log in process to a first server by the client, the first server performs a Kerberos authentification on the client and stores the ticket-granting ticket (TGT) for that client in server memory. The first server then provides the client with a token corresponding to that stored TGT, but does not transmit the TGT itself to the client. When the client requests service from subsequent server, the client provides the token with the request. The subsequent server then requests the client's TGT from the first server using the client-supplied token. The first server retrieves the TGT from memory, and transmits it to the subsequent server. The subsequent server then may use the TGT to determine if the client is authorized to access the service or resource requested.

### BACKGROUND OF THE INVENTION

1. Field of the Invention

This invention relates to the arts of secure login procedures and authentification procedures for networked server and client computers. More particularly, this invention relates to the technologies of multi-server single-sign-on procedures.

2. Background of the Invention

Client-server arrangements are well-known within the art of networked computing. Typically, a client computer may request services and operations from a server computer which is usually located remotely from the client computer. The client and server computers may be interconnected via a computer network such as the Internet, a local area network (“LAN”), or a corporate Intranet.

Server computers can range from a personal computer equipped with appropriate software, all the way up to mainframe and “supercomputer” class machines. Client devices may arrange from simple terminal computers, personal computers, personal digital assistants (“PDA”), and web enabled cell phones as well as Internet appliances.

When requesting a service from a server computer, often a client must be “authenticated” by or for the server prior to receiving the requested service from the server. This is often done using an authentication service known as Kerberos.

Kerberos is an authentication system which was developed at the Massachusetts Institute for Technology (“MIT”), and is designed to allow two parties to exchange private information between an otherwise unsecured network. Basically, Kerberos works by assigning a unique key or “ticket” to each client or user that logs onto the computer network. The ticket or unique key may then be embedded in subsequent messages in order to identify the sender of the message and to authenticate the author or creator of that message to the recipient.

In practice, Kerberos actually comprises three components: (a) an authentication service (“AS”) or key distribution center (“KDC”), a ticket granting service (“TGS”), and the Kerberos protocol.

The Kerberos protocol is used between the client and the authentication server, and TGS. The Kerberos KDC and TGS programs are the authentication and authorization services which run on an authentication server and/or the server from which a service is desired.

Essentially, there are two well-known application programming interfaces for obtaining Kerberos services. The first is Microsoft's Security Support Provider Interface (“SSPI”), and the second is the Generic Security Services Application Programming Interface (“GSSAPI”) which is defined by the Internet Engineering Task Force (“IETF”).

Turning to FIG. 4, the interrelationship and process of performing authentication and obtaining services from a server by a client are shown according to the well-known Kerberos process. First, a client (400) such as a personal computer, sends (41) a log-in user ID and password to the key distribution center (402). If the user ID and password are correct, the KDC responds (42) with a ticket granting ticket (“TGT”), which the client stores.

The client (400) then may provide (44) the TGT to the ticket granting service (TGS), which is usually also running on the KDC (402) in a request for a service ticket for a session with server 1 (S1). The TGS then may respond (43) with a service ticket, which is sent back to the client (400).

The client (400) then may use that service ticket for server 1 in order to obtain service from the first server (401) by sending it (45) to the first server (401). The first server (401) issues (46) a session key to the client, which is then used during service interactions (47) between the client (400) and the first server (401).

If the client subsequently desires to obtain service from a second server (403), or third server, etc., the client sends (48) the TGT to the KDC with a request for a service ticket to the second server. The KDC issues (49) a service ticket for server to the client (400), which the client then sends (404) to the second server (403) in order to obtain (405) a session key from the second server. The session key from the second server is then used during service interactions (406) between the client (400) and the second server (403).

As such, the client (400) must repeatedly request new service tickets for each server and service which the client desires to access from remote servers, and must repeatedly obtain session keys from those servers. Additionally, the client must be able to communicate using the Kerberos protocol, which most web browser products are incapable of doing.

Therefore, there is a need in the art for a “single sign on” system and method for non-Kerberos web clients that need to access multiple servers or services on different hosts which are protected by the Kerberos authentication process. Further, there is a need in the art for this new system and method to maintain comparable security of the current multiple-login process using a Kerberos-compatible client.

### SUMMARY OF THE INVENTION

The present invention provides a single-sign-on (SSO) capability to a non-Kerberos client, such as a common web browser, to allow to access multiple servers in an environment where the servers employ the Kerberos authentification process. During an initial log-in process to a first server by the client, the first server performs a Kerberos authentification with a key distribution center on behalf of the client, and stores the ticket-granting ticket (TGT) for that client in server memory. The first server creates a SSO Token and associated that with the TGT for that client. The SSO Token, but not the TGT, are then provided to the client.

When the client subsequently requests service from second (or subsequent) server, the client transmits its SSO Token along with a request for service to the subsequent server. Instead of the subsequent server performing a new Kerberos authentication on behalf of the client, it requests the client's TGT from the first server using the client-supplied SSO Token. The first server retrieves the client's TGT associated with the SSO Token from its memory, and transmits it to the subsequent server.

Each server that requests and receives a TGT for a client also stores the TGT for that client in its own server memory so that subsequent service requests from the same client will not necessarily require a new SSO Token-TGT exchange with the first server.

This allows the non-Kerberos client to access Kerberos-protected servers using a single-sign on process, and without compromising the security integrity of the Kerberos process.

### BRIEF DESCRIPTION OF THE DRAWINGS

The following detailed description when taken in conjunction with the figures presented herein provide a complete disclosure of the invention.

FIG. 1 depicts a generalized computing platform architecture, such as a personal computer, server computer, personal digital assistant, web-enabled wireless telephone, or other processor-based device.

FIG. 2 shows a generalized organization of software and firmware associated with the generalized architecture of FIG. 1.

FIG. 3 illustrates the logical process and client-server-KDC interrelationships according to the invention.

FIG. 4 graphically depicts the well-known Kerberos authentification process as used for accessing multiple different servers.

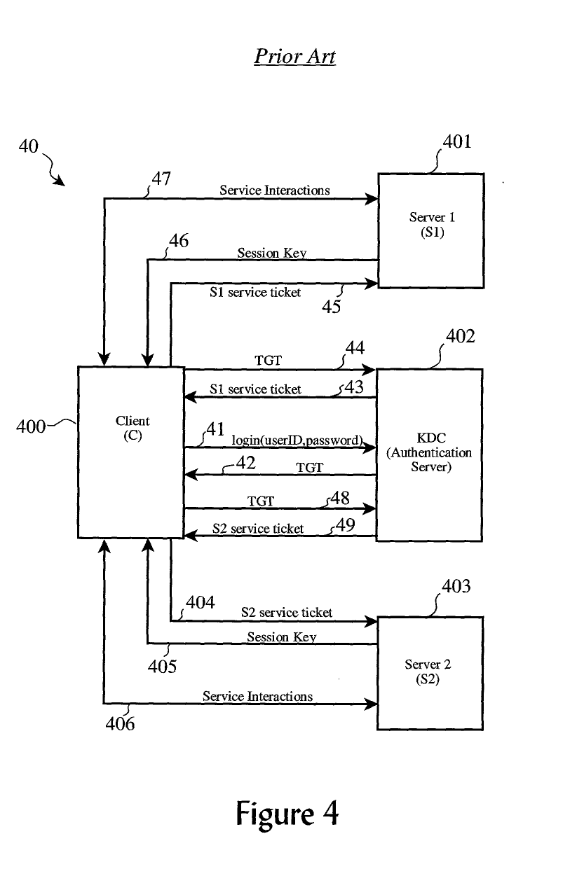

### DETAILED DESCRIPTION OF THE INVENTION

The invention is preferably realized as a feature or addition to the software already found present on well-known client and server computing platforms, such as personal computers, web servers, and web browsers. These common computing platforms can include personal computers as well as portable computing platforms, such as personal digital assistants (“PDA”), web-enabled wireless telephones, and other types of personal information management (“PIM”) devices.

Therefore, it is useful to review a generalized architecture of a computing platform which may span the range of implementation, from a high-end web or enterprise server platform, to a personal computer, to a portable PDA or web-enabled wireless phone.

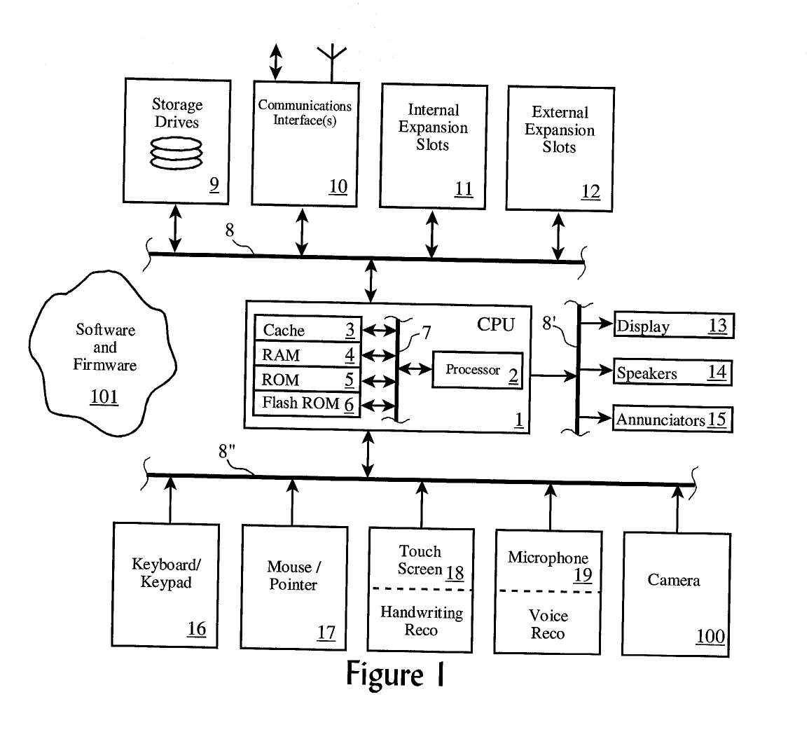

Turning to FIG. 1, a generalized architecture is presented including a central processing unit (1) (“CPU”), which is typically comprised of a microprocessor (2) associated with random access memory (“RAM”) (4) and read-only memory (“ROM”) (5). Often, the CPU (1) is also provided with cache memory (3) and programmable FlashROM (6). The interface (7) between the microprocessor (2) and the various types of CPU memory is often referred to as a “local bus”, but also may be a more generic or industry standard bus.

Many computing platforms are also provided with one or more storage drives (9), such as a hard-disk drives (“HDD”), floppy disk drives, compact disc drives (CD, CD-R, CD-RW, DVD, DVD-R, etc.), and proprietary disk and tape drives (e.g., Iomega Zip [TM] and Jaz [TM], Addonics SuperDisk [TM], etc.). Additionally, some storage drives may be accessible over a computer network.

Many computing platforms are provided with one or more communication interfaces (10), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (11), such as Industry Standard Architecture (ISA), Enhanced Industry Standard Architecture (EISA), Peripheral Component Interconnect (PCI), or proprietary interface slots for the addition of other hardware, such as sound cards, memory boards, and graphics accelerators.

Additionally, many units, such as laptop computers and PDA's, are provided with one or more external expansion slots (12) allowing the user the ability to easily install and remove hardware expansion devices, such as PCMCIA cards, SmartMedia cards, and various proprietary modules such as removable hard drives, CD drives, and floppy drives.

Often, the storage drives (9), communication interfaces (10), internal expansion slots (11) and external expansion slots (12) are interconnected with the CPU (1) via a standard or industry open bus architecture (8), such as ISA, EISA, or PCI. In many cases, the bus (8) may be of a proprietary design.

A computing platform is usually provided with one or more user input devices, such as a keyboard or a keypad (16), and mouse or pointer device (17), and/or a touch-screen display (18). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (18) is usually provided, often with handwriting recognition capabilities.

Additionally, a microphone (19), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (100), such as a still digital camera or full motion video digital camera.

One or more user output devices, such as a display (13), are also provided with most computing platforms. The display (13) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (14) and/or annunciators (15) are often associated with computing platforms, too. The speakers (14) may be used to reproduce audio and music, such as the speaker of a wireless telephone or the speakers of a personal computer. Annunciators (15) may take the form of simple beep emitters or buzzers, commonly found on certain devices such as PDAs and PIMs.

These user input and output devices may be directly interconnected (8′, 8″) to the CPU (1) via a proprietary bus structure and/or interfaces, or they may be interconnected through one or more industry open buses such as ISA, EISA, PCI, etc.

The computing platform is also provided with one or more software and firmware (101) programs to implement the desired functionality of the computing platforms.

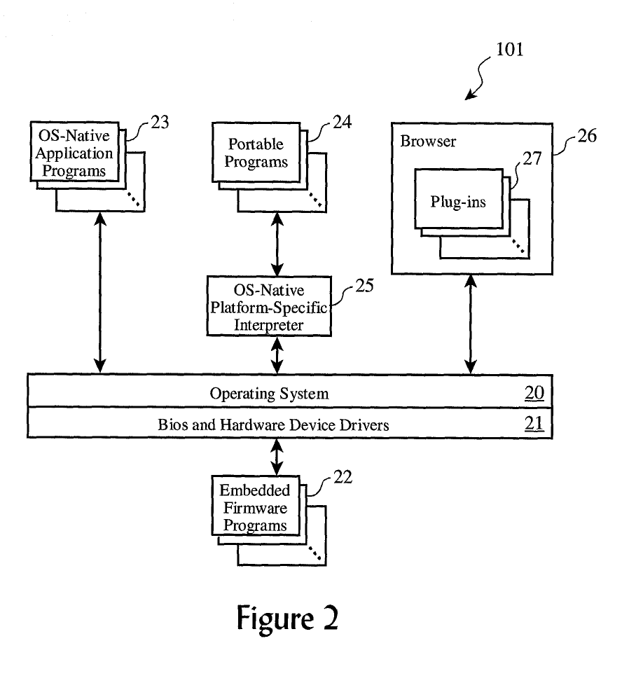

Turning to now FIG. 2, more detail is given of a generalized organization of software and firmware (101) on this range of computing platforms. One or more operating system (“OS”) native application programs (23) may be provided on the computing platform, such as word processors, spreadsheets, contact management utilities, address book, calendar, email client, presentation, financial and bookkeeping programs.

Additionally, one or more “portable” or device-independent programs (24) may be provided, which must be interpreted by an OS-native platform-specific interpreter (25), such as Java [TM] scripts and programs.

Often, computing platforms are also provided with a form of web browser or micro-browser (26), which may also include one or more extensions to the browser such as browser plug-ins (27).

The computing device is often provided with an operating system (20), such as Microsoft Windows [TM], UNIX, IBM OS/2 [TM], LINUX, MAC OS [TM] or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (21) are often provided to allow the operating system (20) and programs to interface to and control the specific hardware functions provided with the computing platform.

Additionally, one or more embedded firmware programs (22) are commonly provided with many computing platforms, which are executed by onboard or “embedded” microprocessors as part of the peripheral device, such as a micro controller or a hard drive, a communication processor, network interface card, or sound or graphics card.

As such, FIGS. 1 and 2 describe in a general sense the various hardware components, software and firmware programs of a wide variety of computing platforms, including but not limited to personal computers, PDAs, PIMs, web-enabled telephones, and other appliances such as WebTV [TM] units.

We now turn our attention to disclosure of the present invention relative to the processes and methods preferably implemented as software and firmware on such computing platforms. It will be readily recognized by those skilled in the art that the following methods and processes may be alternatively realized as hardware functions, in part or in whole, without departing from the spirit and scope of the invention.

The invention and its associated components are preferrably realized as a modification to an existing server software package and client web browser software program. Most well known server software and browser software programs are extendable through the use of dynamic link libraries (DLL), plug-ins, and the like. However, it is also possible to modify the actual code of these programs to implement the processes of the invention, as well, without departing from the spirit and scope of the invention.

According to the preferred embodiment, the invention is implemented to cooperate with one or more server service programs, such as IBM's WebSphere [TM] server product, and one or more client programs such as a web browser, such as Netscape's Navigator [TM] or Microsoft's Internet Explorer [TM].

Because the TGT generated by a first authentification process contains a session key unique to the first server accessed, it cannot be directly re-used for obtaining services from another server according to the Kerberos protocol and processes. But, in order to provide a single-sign on capability and to be compatible with the Kerberos authentication methods, the invention must provide an additional mechanism for allowing subsequent servers to authenticate the user or client.

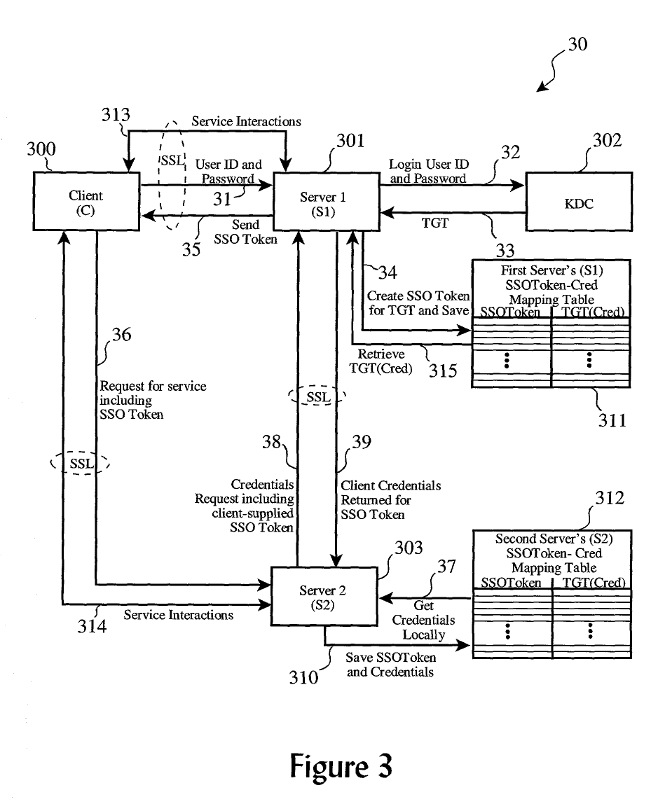

Turning to FIG. 3, the logical process of the invention is disclosed in detail, wherein “C” represents a client (300), “S1” (301) and “S2” (303) represent multiple servers to which the client wishes to have access, and “KDC” (302) represents the Kerberos authentification server (AS) and Ticket Granting Service (TGS) combined. In practice, the AS and TGS may run separately on separate servers or hosts, but are typically run by the same server. For the purposes of our disclosure, we will refer to the KDC has running both the AS and TGS.

According to the invention, each server (301, 303) maintains a mapping table (311, 312) for converting or associating Single Sign On Tokens (“SSOToken”) to previously created TGT Credentials (“TGTCred”). The following method of the invention provides the client with the ability to log in once, or perform a “single sign on” (“SSO”), and to subsequently access services from other servers and hosts without performing additional log in procedures.

First, the client (300) sends (31) a user ID and password to a first server (301) to which the user or client wishes access, preferrably using secure sockets layer (“SSL”) communications. The first server (301) performs a normal Kerberos login to the KDC on behalf of the client by contacting (32) the KDC (302) to obtain a TGT (33) for the client. If the user ID and password are correct, the KDC (302) creates a ticket-granting ticket for the client, and sends (33) the TGT to the first server (301).

In response to this authentication process being completed successfully, the first server (301) then creates a first SSO Token for the TGT, and stores (34) them in a SSOToken-to-Credential mapping table (311), thereby creating an association between the client's TGT and the SSOToken.

Finally, the SSOToken, but not the TGT, is sent (35) to the client (300) by the first server (301) for subsequent use when communicating with the first server and accessing (313) its services.

The SSOToken contains an identifier such as a Universal Resource Locator (“URL”) of the originator of the SSOToken, such as the first server's (301) URL in this example, and an unique identifier, such as a number, for the client to which it was issued. For security purposes, the SSOToken which is supplied to the client does not contain the client's TGT, user ID or password; it just contains a unique number generated by the SSOToken originating server which corresponds to the client's TGT(cred) in the originating server's SSOToken-to-Credential mapping table. An example of such a token is provided in Table 1.

TABLE 1
Example SSO Token Contents
SSOToken number = 9594372; originator_URL = “as.server1.com”

Subsequently, when the client (300) wishes to log into a second (or subsequent) server to access its services, instead of repeating the login process via the subsequent server (with the subsequent server performing another Kerberos login to the KDC), the client (300) simply provides (36) the its SSOToken to the second server (303) when making a service request to the second server (303).

In response to receipt of this request from the client (300), the second server (303) requests (38) the client's credentials from the originator of the SSOToken (using the originator indication from the SSOToken), such as in this example the first server (301).

Next, the originating server (301) retrieves (315) the TGT(Cred) associated with the SSOToken received from the second server (303). Then, the originating server (301) initiates a Generic Security Service (“GSS”) secure association with the second server (303) by using the client's (300) TGT as a forwardable TGT. When this GSS association is complete, the second server (303) will have received (39) client's credentials (TGT).

Preferably, the second server (303) then saves (310) the client's (300) credentials (TGT) in its own SSOToken-to-Credential mapping table (312) for later reference, but it does not send the TGT to the client. Now that the client (300) has been authenticated to the second server (303), the second server may allow access by the client as requested.

Subsequent requests by the same client to the first or second server may not require the exchange of the client credentials with the SSOToken originator as there will already be an entry in the server's own SSOToken-to-Credential mapping table which can be used.

As standard Kerberos TGT's inherently have a “time to live” value stored in them, the entries in the SSOToken-to-Credential mapping tables will automatically expire, thereby triggering periodic re-exchange of credentials with the SSOToken originating server. The process of exchanging the SSOToken for a TGT may be repeated for a plurality of different servers until the original TGT expires.

When the originating server's TGT for a client has expired and a new request for service from the client is received, the originating server may repeat the Kerberos authentication process with the KDC, placing the new credential in its table for later forwarding to other servers.

When the originating server's TGT for a client has expired and a request for a credential is received from another server, the originating server may repeat the Kerberos authentication process with the KDC, and may forward the new client credential to the requesting server. Alternatively, the requesting server may contact the KDC directly to obtain a fresh TGT for the client, in which case the requesting server becomes the new SSOToken originator for subsequent credential requests.

This invention, as described, provides a single sign on capability for client to access a plurality of servers even though the severs employ the Kerberos authentification process, without requiring modification to the standard Kerberos protocol or process and without compromising the security of the Kerberos scheme.

It will be recognized by those skilled in the art that certain modifications, substitutions, and alternate embodiments may be made to the disclosed examples without departing from the spirit and scope of the invention, including but not limited to adoption of alternate programming methodologies, computing platforms, and communications networks and protocols. As such, the scope of the invention should be determined by the following claims.

What is claimed is:

1. A method for providing client single-sign-on (SSO) to a plurality of servers comprising the steps of:
transmitting a set of login parameters from a client to a first server;
performing by said first server an authentication on said set of login parameters using an authentication service, and receiving an authentication approval ticket from said authentication service;
creating a SSOToken responsive by said first server in response to receipt of said authentication approval ticket, said SSOToken with being associated with said authentication approval ticket, said SSOToken having a unique token number and originating server indication;
providing said SSOToken to said client; and
providing said associated authentication approval ticket to a second server upon receipt of a credentials request from said second server, said credentials request containing said SSOToken.

2. The method as set forth in claim 1 wherein said step of performing an authentication comprises performing a Kerberos authentication, wherein said step of receiving an authentication approval ticket comprises receiving a Kerberos ticket-granting ticket, and where said step of providing said associated authentication approval ticket to a second server comprises providing said Kerberos ticket-granting ticket.

3. The method as set forth in claim 1 wherein said step of providing said SSOToken to said client further comprises providing a secure communications link between said first server and said client through which said SSOToken is exchanged.

4. The method as set forth in claim 1 wherein said step of providing said associated authentication approval ticket to a second server further comprises providing a secure communications link between said first server and said second server through which said SSOToken and ticket-granting ticket are exchanged.

5. The method as set forth in claim 1 further comprising the step of checking a local data store of associated SSOTokens and ticket-granting tickets to determine if a ticket-granting ticket has been previously stored for the requesting client, thereby eliminating the need to either perform an authentication with an authentication server or to request credentials from an originating server.

6. A computer-readable medium encoded with software for providing client single-sign-on (SSO) to a plurality of servers, said software causing one or more computers to perform the steps of:
transmitting a set of login parameters from a client to a first server;
performing by said first server an authentication on said set of login parameters using an authentication service, receiving an authentication approval ticket from said authentication service;
creating a SSOToken responsive by said first server in response to receipt of said authentication approval ticket, said SSOToken with being associated with said authentication approval ticket, said SSOToken having a unique token number and originating server indication;
providing said SSOToken to said client; and
providing said associated authentication approval ticket to a second server upon receipt of a credentials request from said second server, said credentials request containing said SSOToken.

7. The computer readable medium as set forth in claim 6 wherein said software for performing an authentication comprises software for performing a Kerberos authentication, wherein said software for receiving an authentication approval ticket comprises software for receiving a Kerberos ticket-granting ticket, and where said software for providing said associated authentication approval ticket to a second server comprises software for providing said Kerberos ticket-granting ticket.

8. The computer readable medium as set forth in claim 6 wherein said software for providing said SSOToken to said client further comprises software for providing a secure communications link between said first server and said client through which said SSOToken is exchanged.

9. The computer readable medium as set forth in claim 6 wherein said software for providing said associated authentication approval ticket to a second server further comprises software for providing a secure communications link between said first server and said second server through which said SSOToken and ticket-granting ticket are exchanged.

10. The computer readable medium as set forth in claim 6 further comprising software for checking a local data store of associated SSOTokens and ticket-granting tickets to determine if a ticket-granting ticket has been previously stored for the requesting client, thereby eliminating the need to either perform an authentication with an authentication server or to request credentials from an originating server.

11. A client single-sign-on (SSO) system for allowing a client to perform one authenticated sign on to a plurality of severs, said system comprising:
an authenticated credential set associated with said client;
a SSO Token containing a unique token identifier and a reference to a first server which received said authenticated credential set;
a SSO Token to credential set storage accessible by said first server and in which said authenticated credential set and SSO Token are stored and associated;
a means for providing said SSO Token to said client; and
a first server means for providing said authenticated credential set associated with said SSO Token to a second server in response to a request for credentials from said second server, said request for credentials containing said SSO Token for said client, thereby providing proxied authentication to said second server from said first server.

12. The system as set forth in claim 11 wherein said authenticated credential set comprises a Kerberos ticket-granting ticket.

13. The system as set forth in claim 11 wherein said means for providing said SSO Token to said client comprises a secure sockets layer communications link.

14. The system as set forth in claim 11 wherein said first server means for providing said authenticated credential set associated with said SSO Token to a second server comprises a secure sockets layer communication link.

15. The system as set forth in claim 11 further comprising a second server storage for caching said SSO Token which is provided by said first server such that said second server may avoid requesting credentials upon subsequent service requests from said client.
